(19) United States
(12) Patent Application Publication
(10) Pub. No.: US 2024/0262326 A1
(43) Pub. Date: Aug. 8, 2024

(54) HYDRAULIC BRAKE DISTRIBUTOR

(71) Applicant: RAICAM DRIVELINE S.R.L., Mondovi' (Cuneo) (IT)

(72) Inventors: Sandro BONARDO, Peveragno (Cuneo) (IT); Benjamin Chetwood STRUVE', Kenilworth Warwickshire (GB)

(21) Appl. No.: 18/565,079

(22) PCT Filed: May 25, 2022
(86) PCT No.: PCT/IB2022/054899

§ 371 Date: Nov. 28, 2023

(30) Foreign Application Priority Data
May 28, 2021 (IT) 102021000013979

(51) Int. Cl. B60T 11/32

(52) U.S. Cl. CPC B60T 11/323

(57) ABSTRACT

A hydraulic brake distributor comprises a first inlet (11) which may be hydraulically connected to a first brake control of a vehicle, a second inlet (16) which may be hydraulically connected to a second brake control of the vehicle, a first outlet (12) which may be hydraulically connected to a first brake of the vehicle, a second outlet (17) which may be hydraulically connected to a second brake of the vehicle, a first channel (13) which sets the first inlet (11) and the first outlet (12) in direct fluid communication, a branch channel (22) which sets the first channel (13) in fluid communication with a first internal cavity (14), and a cutoff valve (14, 18, 24) which is arranged within the first internal cavity (14) and may be actuated in response to brake fluid being sent to the second inlet (16) so as to interrupt the fluid communication through the branch channel (22).

### TECHNICAL FIELD

This invention relates to a hydraulic brake distributor for vehicles, in particular but not exclusively two-wheeled vehicles, which may benefit from combined braking, for example bicycles, motorcycles and scooters.

### BACKGROUND ART

Combined (or integral) braking systems for two-wheeled vehicles are known which are capable of distributing the braking force to both the front wheel and the rear wheel simultaneously. In combined braking systems, instead of assigning the action of the front and rear brakes to two separate controls, at least one of the two controls may simultaneously actuate the front and rear brakes.

Patent publication CN 102582759 B discloses a combined braking system (or integral braking system) comprising a hydraulic brake distributor that has an outer body comprising two inlets and two outlets for the brake fluid. Each of the two inlets is operatively associated with a relevant brake control, and the two outlets are respectively connected in fluid communication to the brake of the front wheel and to the brake of the rear wheel, respectively. A cylindrical cavity is formed inside the body of the actuator, which cavity is in communication with the outlets and the inlets. A single piston valve element provided with sealing gaskets that act against the internal wall of the cylindrical cavity is axially movable within the cylindrical cavity. The actuation of a first of the two brake controls causes the valve element to move, with a consequent flow of brake fluid to both the front and rear brakes simultaneously. The actuation of the second brake control causes brake fluid to flow toward only one of the brakes, either the front or rear.

Patent publication CN 102745293 A discloses a combined braking system comprising a hydraulic brake distributor that has an outer body which forms a cylindrical cavity in communication with two outlets and two inlets for the brake fluid. Two separate valve elements which are axially aligned and axially movable in the cavity are axially movably mounted in the cylindrical cavity. The valve elements are provided with sealing gaskets that act against the internal wall of the cylindrical cavity. The actuation of the first of the two brake controls causes brake fluid to flow into the cylindrical cavity from an inlet arranged in an intermediate position between two piston valve elements. The actuation of the first brake control causes both of the piston valve elements to move, with a consequent simultaneous flow of brake fluid toward both the front and rear brakes. The actuation of the second brake control causes brake fluid to flow toward only one of the brakes, either the front or rear.

The currently known brake distributors have the following disadvantage: if, during braking, the user is already actuating one of the controls that distribute the braking and then also starts to actuate the second control at the same time as the first, the first control receives a hydraulic pulse, triggered by the overpressure induced by the action of the second control, which pulse tends to return the first control towards the release position, contrary to the action that the rider is imparting to the first control. In other words, the user feels a sensation of the first actuated brake being released, because the control lever that was already pulling tends to open when the other brake control lever is pulled.

### SUMMARY OF THE INVENTION

The object of this invention is that of providing a hydraulic distributor which is not affected by the disadvantage set out above.

The aforesaid and other objects and advantages, which will be better understood in the following, are achieved, according to one aspect of this invention, by a hydraulic brake distributor having the features defined in claim 1. Preferred embodiments of the distributor are defined in the dependent claims.

According to one aspect, the invention provides a hydraulic brake distributor, comprising at least one first inlet which may be hydraulically connected to a first brake control of a vehicle, at least one second inlet which may be hydraulically connected to a second brake control of the vehicle, a first outlet which may be hydraulically connected to a first brake of the vehicle, a second outlet which may be hydraulically connected to a second brake of the vehicle, a first channel which sets the first inlet and the first outlet in direct fluid communication, a branch channel which sets the first channel in fluid communication with a first internal cavity, and a cutoff valve which is arranged within the first internal cavity and may be actuated in response to brake fluid being sent to the second inlet so as to interrupt the fluid communication through the branch channel.

According to a further aspect, a hydraulic brake distributor is provided which comprises:
at least one first inlet which may be hydraulically connected to a first brake control of a vehicle;
at least one second inlet which may be hydraulically connected to a second brake control of the vehicle;
a first outlet which may be hydraulically connected to a first brake of the vehicle;
a second outlet which may be hydraulically connected to a second brake of the vehicle;
a first internal cavity which is longitudinally extended and has one end forming a hydraulic cutoff chamber hydraulically connected to the second inlet;
a floating cutoff piston which is longitudinally received in the first internal cavity and elastically urged towards the cutoff chamber;
a first channel which sets the first inlet and the first outlet in direct fluid communication;
a branch channel which sets the first channel in fluid communication with the first internal cavity;
a second longitudinally extended internal cavity which intercommunicates with the first internal cavity through at least two internal passages, the second internal cavity having a first end forming a hydraulic actuation chamber hydraulically connected to the first internal cavity through a first of said internal passages and a second end hydraulically connected to the second outlet;
at least one second passage for intercommunication between said internal passages, which intercommunication passage provides fluid communication between the cutoff chamber and the second internal cavity and opens onto the second internal cavity at a point which is longitudinally intermediate between the first internal passage and the second outlet;
at least one floating piston valve element in the second internal cavity, which element is elastically urged towards the hydraulic actuation chamber;
wherein the cutoff piston has
a passive position, in which the cutoff piston allows fluid communication through the first internal cavity between the branch channel and the first passage to the hydraulic actuation chamber, and
an active position, in which the cutoff chamber is pressurized due to brake fluid being sent to the second inlet, and the cutoff piston closes the branch channel;
and wherein the piston valve element has
a passive position, in which the actuation chamber is not pressurized and the piston valve element allows fluid communication, through the second internal cavity, from the intercommunication passage from the cutoff chamber to the second outlet, and
a position of being at least partially extended towards the second outlet following the pressurization of the hydraulic actuation chamber, in which position a sealing element on the piston valve element acting in sliding contact against the second internal cavity is located in a longitudinally intermediate position between the intercommunication passage and the second outlet, such that said sealing element does not allow direct fluid communication, through the second internal cavity, from the intercommunication passage from the cutoff chamber to the second outlet, and such that the pressurization of the cutoff chamber may move at least a part of the piston valve element further towards the second outlet.

### BRIEF DESCRIPTION OF THE DRAWINGS

Some preferred but non-limiting embodiments of a hydraulic brake distributor according to the invention will now be described, with reference to the accompanying drawings, in which:

FIGS. 1 and 2 are perspective views, from different angles, of a hydraulic brake distributor according to an embodiment of this invention;

FIGS. 3 to 8 are schematic longitudinal sectional views that illustrate a hydraulic brake distributor according to an embodiment of the invention in various operating conditions; and

FIGS. 9 to 11 are schematic cross-sectional views that illustrate a hydraulic brake distributor according to another embodiment of the invention in various operating conditions.

### DETAILED DESCRIPTION

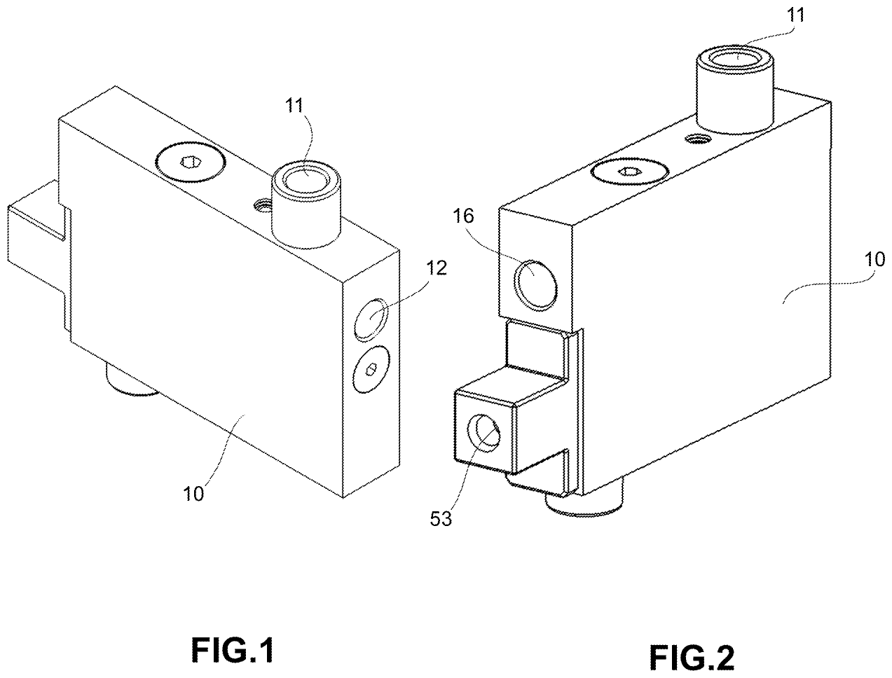

With initial reference to FIGS. 1-3, reference number 10 indicates, as a whole, a body of a hydraulic brake distributor. The body 10 is made of a rigid material, for example an aluminum alloy, in which a plurality of internal cavities, inlets and outlets, and internal channels for communication therebetween are formed.

A first inlet 11 may be hydraulically connected to a first brake pump (not shown) and actuated by a relevant first control (not shown). In a bicycle, this first control may typically be a control lever mounted on the left-hand side of the handlebar. A first outlet 12 may be hydraulically connected to a first brake of the vehicle, typically a brake caliper of the front wheel.

The first inlet 11 and the first outlet 12 are directly connected to one another by means of a first internal channel 13 which comprises two sections 13a and 13b that are connected to the first inlet 11 and to the first outlet 12, respectively. This direct hydraulic communication makes it possible to directly actuate the brake of the front wheel upon actuation of the first control.

Two intercommunicating internal cavities 14, 15 are formed in the body 10: a first cavity 14, which in this example has a single-diameter cylindrical shape, and a second cylindrical internal cavity, which in this example has a double diameter having a section 15a having a smaller diameter and a section 15b having a larger diameter.

A second inlet 16 may be hydraulically connected to a second brake pump (not shown) and actuated by a relevant second control (not shown). In a bicycle, the second control may be a control lever mounted on the right-hand side of the handlebar. A second outlet 17 may be hydraulically connected to a second brake of the vehicle, typically a brake caliper of the rear wheel.

The brake distributor incorporates a cutoff valve (or shutoff valve) intended to selectively isolate the operation of the first brake from the rest of the braking system, thus making the control of the first brake unresponsive to the action of the second control.

The terms “front” and “rear”, with regard to the first and second brake and the first and second control, should not be understood as being limited to the application of the brake distributor on a vehicle, for example a bicycle. As will become clear from reading the description that follows, the first inlet and the first outlet, which are directly hydraulically connected, may be swapped, by the first brake control being connected to the outlet 12 and the first brake being connected to the first inlet 11.

A cutoff valve is formed by a cutoff valve or piston element 18 which is axially movable in the first internal cavity 14. A compression spring 19 elastically urges the cutoff piston 18 towards a bottom wall 20 of the first internal cavity 14, where a channel 21 that communicates with the second inlet 16 opens.

In this context, terms indicating positions and orientations such as “axial” or “longitudinal” and “transverse” or “radial” are understood to refer to the directions in which the piston elements described herein extend and move. Terms such as “upstream” or “downstream” are understood to refer to the direction of a fluid flow actuated by one of the brake controls.

A branch channel 22 which communicates with the first internal channel 13 establishes fluid communication between the first internal channel 13 (and thus the first inlet 11 and the first outlet 12) and the first internal cavity 14. The branch channel 22 opens onto the first internal cavity by means of a port 23 located in a longitudinally intermediate position between the bottom wall 20 and the compression spring 19.

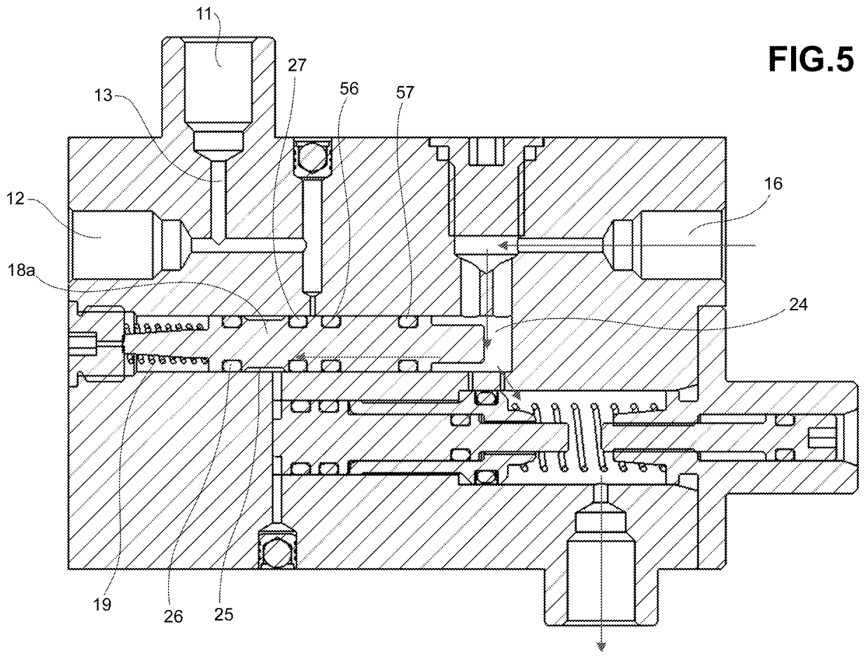

The first internal cavity 14 has an end section which comprises the bottom wall 20 and which, together with the side of the cutoff piston 18 that faces the bottom wall 20, forms a hydraulic cutoff chamber 24 (best seen in FIG. 5).

The hydraulic cutoff chamber 24 is in fluid communication with the second inlet 16 by means of the channel 21, and may be expanded as a result of brake fluid being sent from the second inlet 16, which moves the cutoff piston 18 counter to the elastic action of the compression spring 19.

The cutoff piston 18 preferably has an end section 18b having a recess or a reduced diameter, which end section faces the bottom wall 20 and forms part of the hydraulic cutoff chamber 24.

The cutoff piston 18 has an intermediate section 18a having a reduced diameter, which intermediate section, together with the cylindrical wall of the first internal cavity 14, determines an axially extended annular gap 25. The annular gap 25 is longitudinally between two sealing gaskets 26, 27 which are arranged on the cutoff piston 18 and act in sliding contact against the first internal cavity 14.

One or two further sealing gaskets 56, 57 which act in sliding contact against the first internal cavity 14 are arranged on the cutoff piston 18 in positions longitudinally between the port 23 of the branch channel 22 and the cutoff chamber 24.

As will be explained in the following, the cutoff valve has the effect of preventing the rider from feeling, on the already actuated first control, as described in the introduction, the subsequent action of the second control.

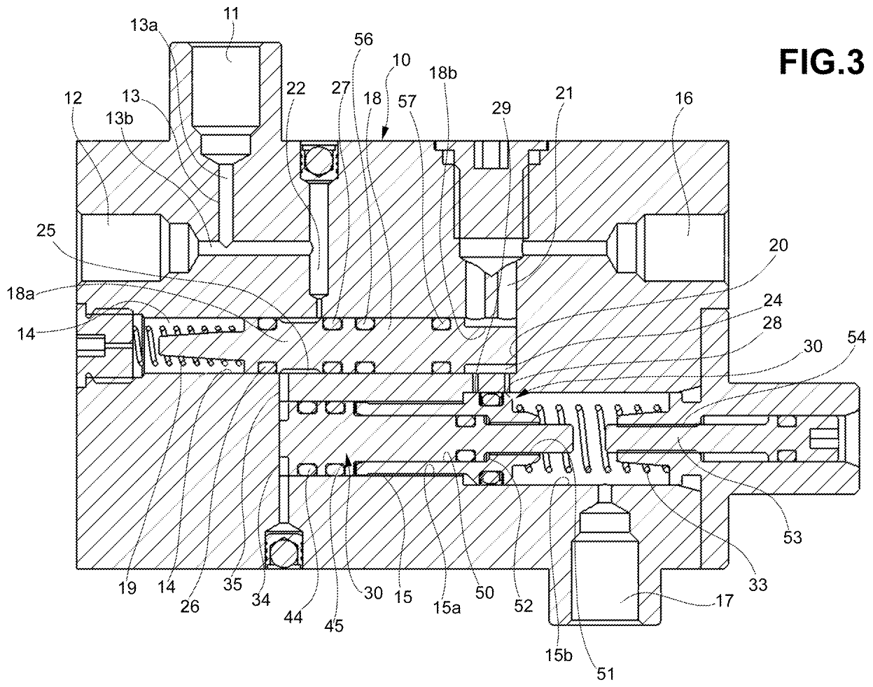

The second internal cavity 15 accommodates, in an axially movable manner, at least one floating piston valve actuator 30 which, in the embodiment in FIG. 3-8, is designed as a double piston which comprises two parts 31, 32 that are movable relative to one another in a longitudinal direction.

The second internal cavity 15 communicates directly with the second outlet 17 which may be hydraulically connected to the second brake (the rear brake) of the vehicle.

The cutoff chamber 24 communicates hydraulically with the second internal cavity 15, for the actuation of the second brake, through two longitudinally spaced inlet ports 28, 29.

A compression spring 33 is provided in the second hydraulic chamber 15, which compression spring elastically biases the floating piston valve actuator 30 towards a bottom wall 34 of the second internal cavity 15. The second internal cavity 15 has an end section which comprises the bottom wall 34 and which, together with the side of the floating piston valve actuator 30 that faces the bottom wall 34, forms a chamber 36 for actuating the floating piston actuator 30. A passage 35 sets the annular gap 25 in the first internal cavity 14 in fluid communication with the hydraulic actuation chamber 36 in the second internal cavity 15.

In the embodiment shown in FIGS. 3-8, the floating piston valve actuator 30 comprises a first inner or central piston element 31, and a second outer piston element 32 which is mounted coaxially on the outside and telescopically slidable on the first piston element 21.

The first piston element 31 has an end surface 37 facing the bottom wall 34 of the second internal cavity 15. The end surface 37 preferably forms a recess 38 or a portion having a reduced diameter that forms part of the hydraulic actuation chamber 36.

The first piston element 31 comprises a base portion 39 having a larger diameter, a stem portion 41 axially opposite the base portion and having a diameter or transverse dimension smaller than that of the base portion 39, and an intermediate portion 40 having an intermediate diameter between those of the base portion 39 and stem portion 41. Two radial shoulders 42, 43 are defined between the base, intermediate and stem portions.

The base portion has at least one (in this example two) sealing gaskets 44, 45 which act in sliding contact against the smaller-diameter section 15a of the second internal cavity 15.

The second piston element 32 has a varying but overall tubular shape through which the intermediate portion 40 and the stem portion 41 of the first piston element 31 pass. The second piston element 32 forms a tubular portion 46 mounted in an axially slidable manner on the axially intermediate portion 40 of the first piston element 31, and a head portion 47 which has a sealing gasket 48 acting in sliding contact against the smaller-diameter section 15b of the second internal cavity 15.

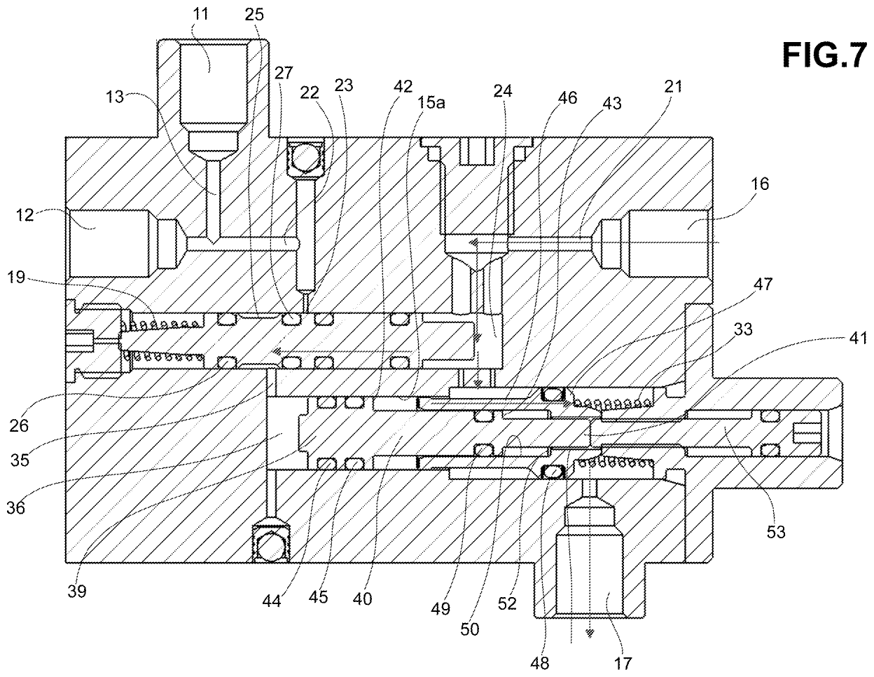

A double-diameter central passage 50, 51 extends longitudinally through the second piston element 32 and has a transversely wider section 50 and a transversely narrower section 51 joined by a shoulder 52 (FIG. 7).

The first and the second piston elements are sealingly coupled to one another by means of a sliding contact sealing element 49.

In the example embodiment in FIGS. 3-8, the intermediate portion 40 of the first piston element carries a sealing gasket 49 which acts in sliding contact against a cylindrical cavity 50 formed in the tubular portion 46 of the second piston element 32.

The actuation chamber 36 of the floating piston valve actuator 30 is hydraulically sealed with respect to the second outlet 17 by the sealing elements 44, 46, 48 and 49 which are mounted collectively on the floating piston valve actuator 30.

In the embodiments shown herein, in order to optimize the dimensions of the brake distributor, the two internal cavities 14 and 15 are parallel and contiguous, and contain respective piston elements which are biased in parallel and opposite directions.

The brake distributor has a rest position shown in FIG. 3. The cutoff piston 18 is in a retracted and inactive position in which the spring 19 is relaxed. The cutoff piston 18 abuts against the bottom wall 20 of the first cylindrical cavity 14, and the port 23 of the branch channel 22 is in fluid communication with the annular gap 25. The annular gap 25 is in fluid communication, through the passage 35, with the hydraulic chamber 36. The floating piston valve element 30 is in an inactive and retracted position. The compression spring 33 elastically urges the floating piston valve actuator 30 towards the bottom wall 34 of the second internal cavity 15; the compression spring 33 acts against the second piston element 32 which, on account of the abutment between the radial shoulders 42 and 52, also urges the first piston element 31 towards and against the bottom wall 34 of the second internal cavity 15.

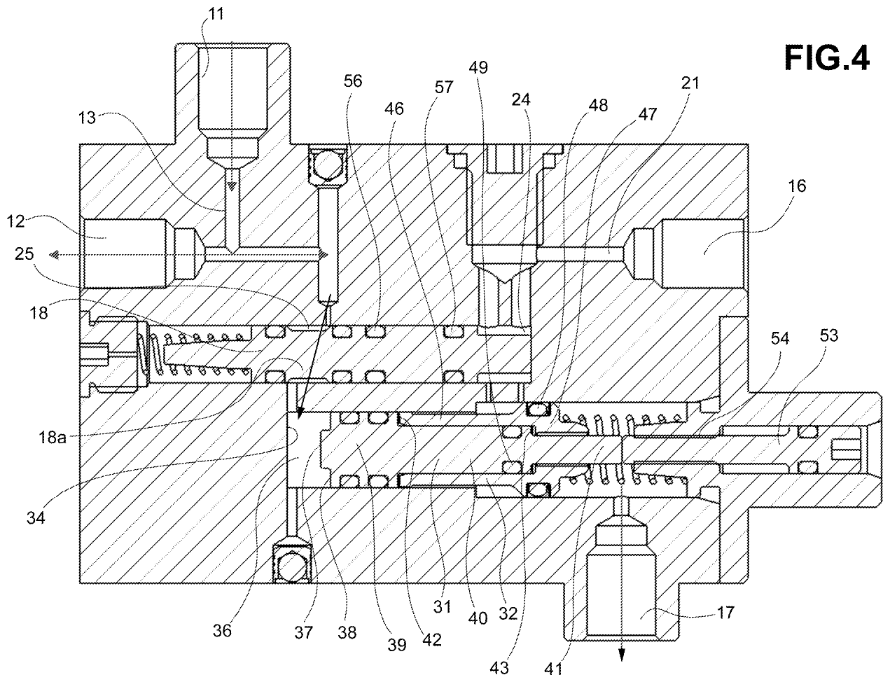

From the rest position in FIG. 3, when the user actuates the first brake control, said control sends the brake fluid to the first inlet 11 of the brake distributor. A first part of the incoming fluid passes directly through the channel 13a, 13b to the first outlet 12 in order to directly actuate the first brake. A second part of the fluid entering the first outlet 11 passes into the branch 22, passes through the port 23 into the annular gap 25 around the cutoff piston 18 without moving it, and reaches the base of the hydraulic chamber 36 (FIG. 4), pushing both of the two piston elements 31, 32 towards the right, counter to the action of the compression spring 33.

The advancing movement of the piston elements 31, 32, in response to brake fluid being sent into the hydraulic actuation chamber 36, reduces the volume available for the brake fluid inside the section 15b of the second internal cavity 15 and causes pressurized brake fluid to be sent from the second outlet 17 towards the second brake.

It should be noted that the brake fluid sent from the first control is separate from the brake fluid that reaches the second brake, and does not reach the second brake; in fact, the brake fluid that flows into the branch 22 remains contained in the hydraulic chamber 36, without reaching the second outlet 17.

Moreover, it should be noted that the brake fluid passing through the first internal cavity, in the passage from the branch channel 22 to the actuation chamber 36, does not cause the cutoff piston 18 to move.

The fully extended position of the two piston elements 31, 32 (FIG. 4) may be determined by a longitudinally adjustable end stop element 53, for example by means of a threaded coupling 54. In the maximally extended position, the end of the stem portion 41 abuts against the end stop element 53.

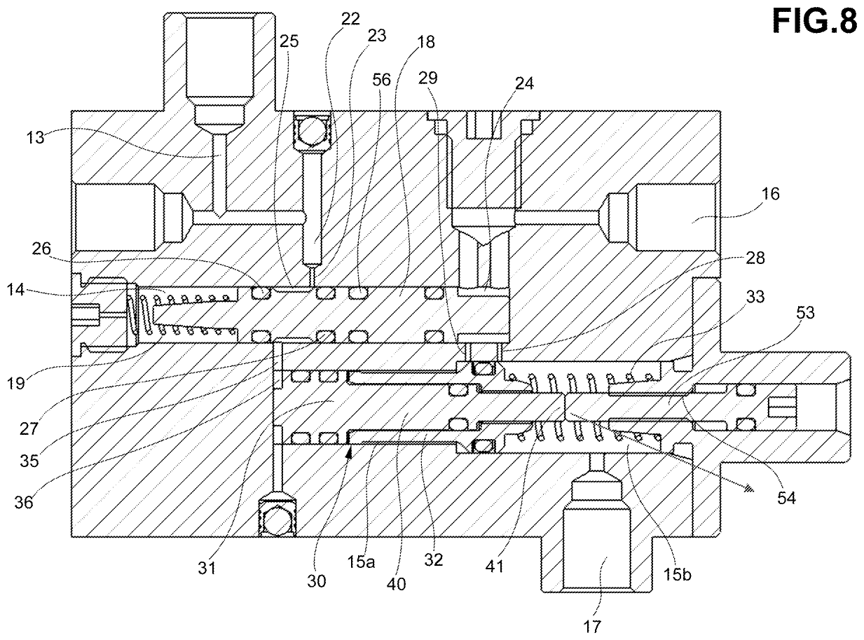

In some embodiments, the distribution of the braking may be selectively inhibited (FIG. 8) by adjusting the position of the end stop element 53, advancing it into a position in which the floating annular piston element 30 is longitudinally blocked against the bottom wall 34 of the second internal cavity 15. In this operating mode, the introduction of brake fluid into the first inlet 11 only causes the fluid to pass directly to the first outlet 12 through the channel 13, without fluid moving through the branch 22.

The optional choice of producing the second internal cavity 15 so as to have two sections having different diameters makes it possible to adjust the percentage amount of brake fluid sent to the second brake. By dimensioning the second section 15b of the second internal cavity so as to have a larger diameter than the diameter of the corresponding cavity in the first section 15a thereof, which receives the brake fluid from the first brake control, a predetermined quantity of brake fluid is introduced into the left-hand part 15a of the second hydraulic cavity, and this, as a result of the translation of the floating piston valve element 30, causes a greater outflow of brake fluid from the right-hand and wider section 15b of the second cavity towards the second brake. In other words, a smaller amount of brake fluid introduced upstream of the floating piston valve actuator 30 moves a greater quantity of brake fluid downstream of said piston valve actuator. The larger the diameter of the second section of the second internal cavity with respect to the first section 15a, the greater the intensity of the braking force imparted to the second brake as a result of actuating the first brake control.

In some embodiments that are not shown, as alternatives to the embodiment shown in FIGS. 3-8, the second internal cavity 15 may have a single diameter. In other different embodiments (not shown), the second internal cavity may have a section having a smaller diameter in the second section where the second outlet 17 opens, and a greater diameter in the first section which receives brake fluid from the first inlet 11.

If the user actuates only the second brake control, which is typically intended to actuate the second brake (the rear brake), the brake fluid introduced into the distributor through the second inlet 16 passes through the distributor and flows to the second outlet 17 towards the second brake. In particular, the brake fluid from the second inlet 16 reaches the cutoff chamber 24 of the first internal cavity 14, moving the cutoff piston from the rest position (FIG. 3) to an active position (FIG. 5), and thus passing through the inlet port 28 into the section 15b of the second internal cavity, and from there to the second outlet 17 towards the second brake. The sealing gaskets 56, 57 arranged on the cutoff piston 18 prevent the brake fluid in the cutoff chamber 24 from reaching the branch channel 22 and thus the first outlet 12 and the first inlet 11. Actuating only the second brake control and not also the first brake control thus brings about the actuation of only the second brake, since the cutoff valve excludes any fluid communication at the second inlet to the first outlet 12.

It is noted that the actuation of only the second brake control is not felt by the user on the first control, on account of the sealing gaskets 56, 57 on the cutoff piston 18 which prevent the fluid from passing from the cutoff chamber 24 to the first inlet 11. Any actuation of the first brake control while the user is still actuating the second brake control results in brake fluid being sent from the first inlet 11 directly and only to the first outlet 12 towards the first brake through the channel 13, but does not cause any further brake fluid to be sent to the second outlet, since the gasket 27 on the cutoff piston 18 (FIG. 5) is arranged between the branch channel 22 and the passage 35 that leads to the hydraulic chamber 36.

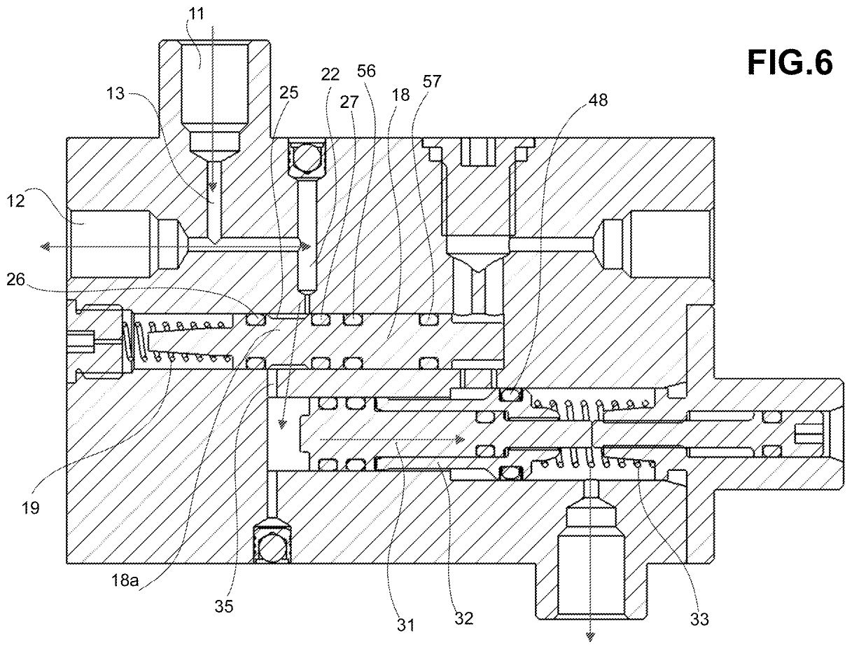

With reference to FIGS. 6 and 7, the operation of the hydraulic distributor is described when acting first on the first brake control, which typically primarily controls the front brake, and subsequently also actuating the second brake control. Actuating the first control causes fluid to pass directly from the first inlet 11 to the first outlet 12 and this flow to be partitioned; the flow is partly diverted through the branch channel 22, flows into the annular gap 25 around the cutoff piston 18, and, through the passage 35, thus reaches the hydraulic actuation chamber 36 of the floating piston valve actuator 30.

The two inner and outer piston elements 31, 32 of the floating piston valve actuator 30 are moved integrally to the right (FIG. 6), counter to the spring 33, causing the flow of a first quantity of brake fluid contained in the from the second internal cavity 15, downstream of the double piston, to the second brake, until the inner piston element reaches the stop 53. The compression spring 33 is only partially compressed. Therefore, in this first braking phase, the second brake is actuated only by the first control. It is noted (FIG. 6) that the translation downstream (to the right) of the floating piston valve actuator 30 causes the gasket 48 on the outer piston element 31 to cross the two intercommunication ports 28, 29, thus preventing the brake fluid from passing directly from the cutoff chamber 24 towards the second outlet 17.

When the user also acts on the second control (FIG. 7), the braking force acting on the second brake increases because the caliper of the second brake receives a further pressure pulse, described in the following. The brake fluid introduced by the second inlet 16 reaches the cutoff chamber 24 of the first internal cavity 14, moving the cutoff piston 18 from the rest position (FIG. 6) to the active position (FIG. 7). The gaskets 56 and 57 on the cutoff piston 18 are arranged longitudinally between the cutoff chamber 24 and the branch channel 22, as a result of which the first inlet 11 and the first control upstream thereof are not affected by the pressurization in the cutoff chamber 24. As a result thereof, the user does not feel, on the already actuated first control, the action of the second control which is actuated after the first.

The brake fluid passes from the cutoff chamber 24 through the intercommunication ports 28, 29 into the second internal cavity 15 upstream of the gasket 48 on the outer piston 32 and therearound, thus causing a further translation of the second outer piston element 32, which slides telescopically on the first piston element 31, thus further compressing the spring 33 and causing a further increase in pressure of the brake fluid towards the second outlet 17 and the second brake. This imparts an additional braking force which acts on the second brake in addition to the braking force that is already active and caused by the actuation of the first control.

When the user acts instead on the second brake control, and subsequently begins to also actuate the first brake control at the same time as the second, the distributor makes the two braking actions independent, according to a non-combined braking mode. The braking action resulting from the actuation of the second control involves brake fluid being sent directly to the second brake, from the second inlet 16 to the second outlet 17, passing through the cutoff chamber 24 and the section 15b of the second hydraulic cavity downstream of the floating piston valve actuator 30. The pressurization in the cutoff chamber 24 causes the cutoff piston 18 to move to the left, subsequently closing the branch passage 22. Therefore, the subsequent flow of pressurized brake fluid to the first inlet 11 causes the fluid to pass directly from the first inlet 11 to the first outlet 12 through the channel 13, according to a braking mode independent of the actuation of the second control.

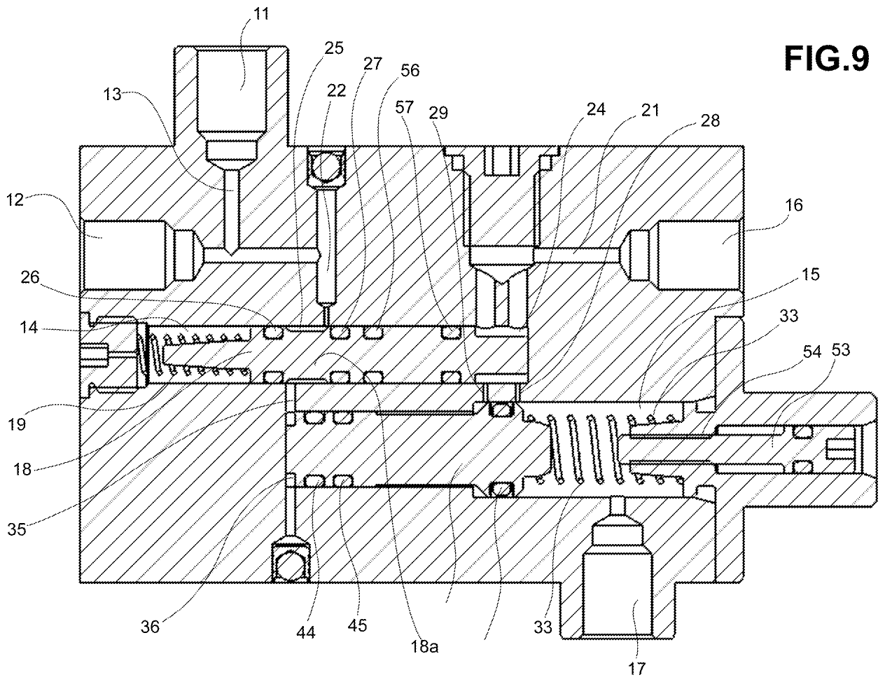

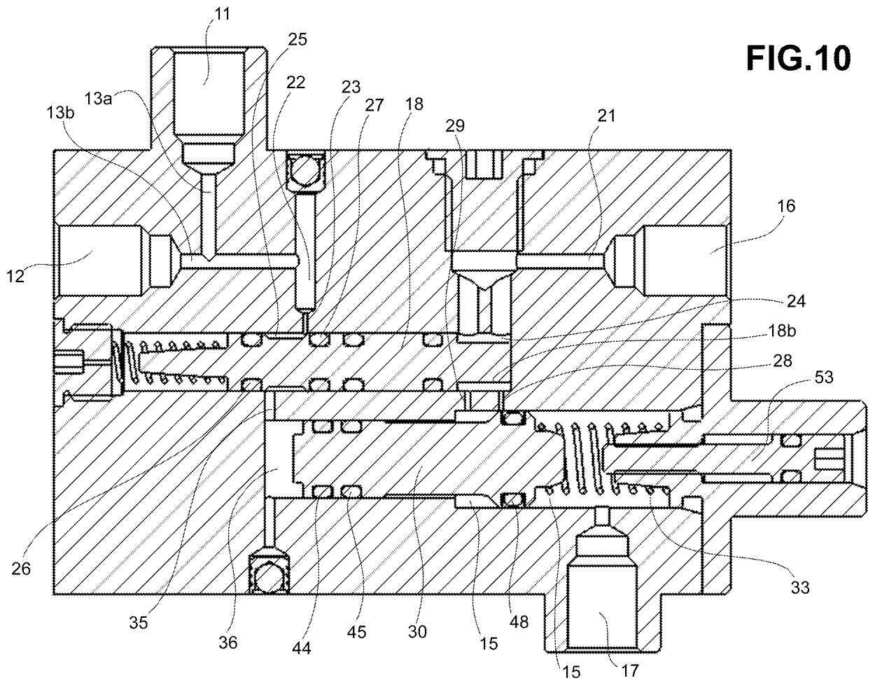

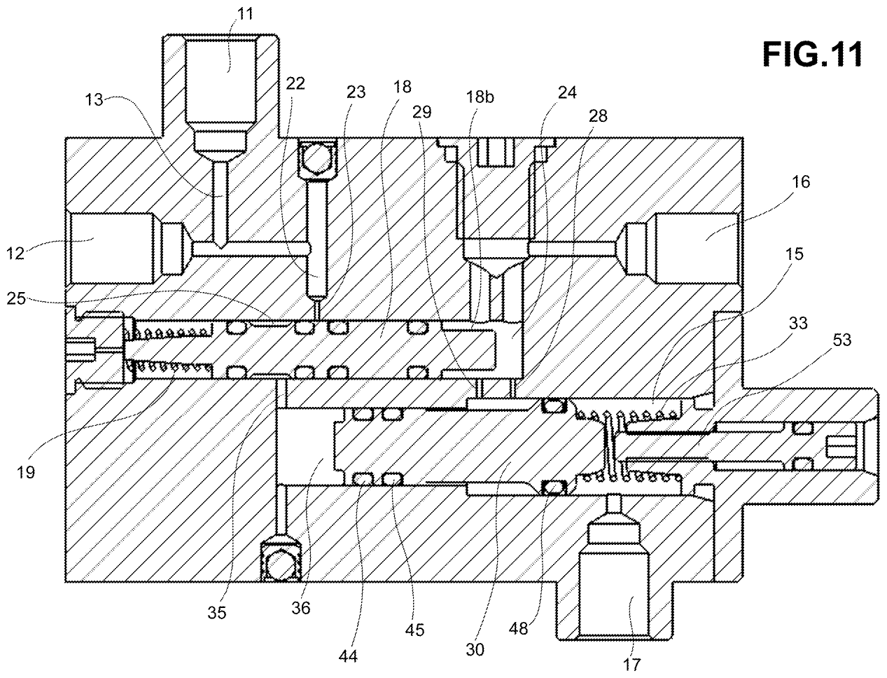

In an alternative embodiment, shown in FIG. 9-11, the floating piston valve actuator 30 is composed of a single piston element. This element, from the rest position (FIG. 9), carries out a first advancing movement as a result of the expansion of the hydraulic chamber 36 when the user actuates the first brake control (FIG. 10), and a second additional advancing movement (FIG. 11) when the user starts to also actuate the second brake control.

As may be appreciated, the braking action on the second brake (for example the brake of the rear wheel) caused by acting on the second control may not be perceptible to the hand of the user actuating the first control, since the action of the cutoff valve allows only direct flow from the first inlet to the first outlet.

It is noted that the connections indicated herein as the first inlet and first outlet may be connected interchangeably, as stated to the first brake control and to the first brake, respectively, or vice versa.

Moreover, according to an alternative operating mode discussed above, where the first brake is the front brake and is the independent brake, the connections of the distributor may be reversed. According to this alternative mode of connection, the first outlet is hydraulically connected to the rear brake and the second outlet is connected to the front brake. Consequently, the distributor causes only the rear wheel to be braked when the first control is actuated, and causes combined braking on the front and rear wheels when the second control is actuated; in this operating mode, the rear wheel is the independent wheel.

Various aspects and embodiments of the brake distributor have been described; it is understood that each embodiment may be combined with any other embodiment. Furthermore, the embodiments and the details of construction may be widely varied with respect to that which has been described and illustrated purely by way of non-limiting example, without thereby departing from the scope of the invention, as defined in the appended claims.

1. A hydraulic brake distributor, comprising:
at least one first inlet (11) hydraulically connectable to a first brake control of a vehicle;
at least one second inlet (16) hydraulically connectable to a second brake control of the vehicle;
a first outlet (12) hydraulically connectable to a first brake of the vehicle;
a second outlet (17) hydraulically connectable to a second brake of the vehicle;
a first channel (13) setting the first inlet (11) and the first outlet (12) in direct fluid communication;
a branch channel (22) setting the first channel (13) in fluid communication with a first internal cavity (14); and
a cutoff valve (14, 18, 24) arranged within the first internal cavity (14) and actuated in response to brake fluid being sent to the second inlet (16) so as to interrupt the fluid communication through the branch channel (22).

2. A hydraulic brake distributor according to claim 1, comprising:
said first internal cavity (14), the cavity being longitudinally extended and having one end forming a hydraulic cutoff chamber (24) hydraulically connected to the second inlet (16);
a floating cutoff piston (18) longitudinally received in the first internal cavity (14) and elastically urged towards the cutoff chamber (24);
a second longitudinally extended internal cavity (15), intercommunicating with the first internal cavity through at least two internal passages (28, 35), the second internal cavity (15) having a first end forming a hydraulic actuation chamber (36) hydraulically connected to the first internal cavity (14) through a first one (35) of said internal passages and a second end hydraulically connected to the second outlet (17);
at least one second intercommunication passage (28, 29) for intercommunication between said internal passages, which intercommunication passage provides fluid communication between the cutoff chamber (24) and the second internal cavity (15) and opens onto the second internal cavity (15) at a point which is longitudinally intermediate between the first internal passage (35) and the second outlet (17);
at least one floating piston valve element (30) in the second internal cavity (15), elastically urged towards the hydraulic actuation chamber (36);
wherein the cutoff piston (18) has
a passive position, in which the cutoff piston (18) allows fluid communication through the first internal cavity (14) between the branch channel (22) and the first passage (35) to the hydraulic actuation chamber (36), and
an active position, in which the cutoff chamber (24) is pressurized due to brake fluid being sent to the second inlet (16), and the cutoff piston (18) closes the branch channel (22);
and wherein the piston valve element (30) has
a passive position, in which the actuation chamber (36) is not pressurized and the piston valve element (30) allows fluid communication, through the second internal cavity (15), from the intercommunication passage (28) from the cutoff chamber (24) to the second output (17), and
an at least partially extended position towards the second outlet (17), responsive to pressurization of the hydraulic actuation chamber (36), in which position a sealing element (48) on the piston valve element (30) acting in sliding contact against the second internal cavity (15) is located in a longitudinally intermediate position between the intercommunication passage (28) and the second outlet (17), whereby said sealing element (48) does not allow direct fluid communication, through the second internal cavity (15), from the intercommunication passage (28) from the cutoff chamber (24) to the second outlet (17), and whereby pressurization of the cutoff chamber (24) can move at least a part of the piston valve element (30) further towards the second outlet (17).

3. A hydraulic brake distributor according to claim 2, wherein the cutoff piston (18) has an intermediate section (18a) having a reduced diameter longitudinally comprised between two sealing gaskets (26, 27) which are arranged on the cutoff piston and act in sliding contact against the first internal cavity (14), whereby the intermediate section (18a) of reduced diameter determines, together with the first internal cavity (14), an axially extended annular gap (25) which, in the passive position of the cutoff piston (18), is in fluid communication with the first passage (35) and with the branch channel (22).

4. A hydraulic brake distributor according to claim 2 or 3, wherein the cutoff piston (18) has an end section (18b) having a recess or a reduced diameter, which end section faces a bottom wall (20) of the first cavity internal (14) and forms part of the hydraulic cutoff chamber (24).

5. A hydraulic brake distributor according to any one of claims 2 to 4, wherein the cutoff piston (18) has at least one further sealing gasket (56, 57) acting in sliding contact against the first internal cavity (14) and mounted on the cutoff piston (18) in at least one position longitudinally intermediate between the cutoff chamber (24) and a port (23) where the branch channel (22) opens onto the first internal cavity (14).

6. A hydraulic brake distributor according to any one of the preceding claims, wherein the cutoff chamber (24) communicates hydraulically with the second internal cavity (15) through two longitudinally spaced intercommunication passages (28, 29).

7. A hydraulic brake distributor according to any one of the preceding claims, wherein the second internal cavity (15) is a double-diameter cylindrical cavity, having a section (15a) that has a smaller diameter and a section (15b) that has a larger diameter.

8. A hydraulic brake distributor according to any one of the preceding claims, wherein the floating piston valve actuator (30) is designed as a double piston which includes two parts (31, 32) that may move relative to one another in the longitudinal direction, comprising
a first radially inner or central piston element (31),
a second radially outer piston element (32) which is mounted coaxially and telescopically slidable on the first piston element (31), and
at least one sliding contact sealing element (49) performing a sliding contact sealing action between the first piston element (31) and the second piston element (32).

9. A hydraulic brake distributor according to claim 8, wherein the first piston element (31) has an end surface (37) forming a recess (38) or a portion having a reduced diameter, which end surface faces a bottom wall (34) of the second internal cavity (15), wherein said recess or end portion (38) having a reduced diameter delimits part of the hydraulic actuation chamber (36).

10. A hydraulic brake distributor according to claim 8 or 9, wherein the first piston element (31) comprises a base portion (39) having a larger diameter, a stem portion (41) longitudinally opposite the base portion and having a diameter or transverse size smaller than that of the base portion (39), and an intermediate portion (40) having an intermediate diameter between those of the base portion (39) and stem portion (41).

11. A hydraulic brake distributor according to claim 10, wherein the base portion (39) of the first piston element (31) has at least one sealing gasket (44, 45) acting in sliding contact against the second internal cavity (15).

12. A hydraulic brake distributor according to claim 10 or 11, wherein the second piston element (32) has an overall variously shaped tubular shape inserted on and passed through by the intermediate portion (40) and the stem portion (41) of the first piston element (31).

13. A hydraulic brake distributor according to claim 10 or 11 or 12, wherein the second piston element (32) has a tubular portion (46) mounted in an axially slidable manner on the axially intermediate portion (40) of the first piston element (31), and a head portion (47) having said sealing element (48) acting in sliding contact against the second internal cavity (15).

14. A hydraulic brake distributor according to any one of claims 10 to 13, wherein the second piston element (32) has a double-diameter central passage (50, 51) extending longitudinally through the second piston element (32), and having a wider section (50) and a narrower section (51) joined by a shoulder (52).

15. A hydraulic brake distributor according to claims 10 and 14, wherein the intermediate portion (40) of the first piston element (31) carries the sealing element (49) which acts in sliding contact against the wider section (50) of the double-diameter central passage of the second piston element (32).

16. A hydraulic brake distributor according to any one of claims 8 to 15, wherein a compression spring (33) longitudinally urges the second piston element (32) towards the first piston element (31) and towards the hydraulic actuation chamber (36).

17. A hydraulic brake distributor according to any one of claims 2 to 7, wherein the floating piston valve actuator (30) is composed of a single piston element (31) having
said sealing element (48) which acts in sliding contact against the second internal cavity (15) and which, in said at least partially extended position, is in a longitudinally intermediate position between the intercommunication passage (28) and the second outlet (17), and
at least one further sealing gasket (44, 45) acting in sliding contact against the second internal cavity (15) at one end of the piston valve actuator (30) closest to the hydraulic actuation chamber (36).

18. A hydraulic brake distributor according to any one of claims 2 to 17, wherein the two internal cavities (14, 15) are parallel and contiguous.

19. A hydraulic brake distributor according to claim 18, wherein the cutoff piston (18) in the first internal cavity (14) is biased in a first direction, and the piston valve element (30) in the second internal cavity (15) is biased in a second direction parallel and opposite to the first direction.
